(19) United States
(12) Patent Application Publication
(10) Pub. No.: US 2010/0177521 A1
(43) Pub. Date: Jul. 15, 2010

(54) Led lamp

(75) Inventor: Ke-Chin Lee, Taipei (TW)

Correspondence Address: COOPER & DUNHAM, LLP, 30 Rockefeller Plaza, 20th Floor, NEW YORK, NY, 10112, US

(73) Assignee: Yeh-Chiang Technology Corp.

(21) Appl. No.: 12/319,995

(22) Filed: Jan. 14, 2009

(51) Int. Cl. F21V 29/00

(52) U.S. Cl. 362/373

(57) ABSTRACT

An LED lamp has a metal housing, a heat pipe and an LED. The metal housing has an outer surface, an inner surface, a bottom and an opening defined by an inner edge. The heat pipe engages the inner surface, the bottom and the inner edge of the metal housing. The LED is attached to the bottom portion of the heat pipe. The heat pipe rapidly transports heat generated by the LED to the metal housing which then transfers heat to the environment. The heat pipe makes effective heat transportation possible and allows the use of high-power LEDs or multiple LED's within one lamp.

### BACKGROUND OF THE INVENTION

1. Field of the Invention

The field of this invention is electric lamps and, in particular, LED (light-emitting diode) lamps.

2. Description of the Prior Art

With reference to FIG. 6, a conventional LED lamp generally comprises a metal rod (91) having two ends and an outer surface. An LED (92) is attached to one end of the metal rod (91). Heat-transferring fins are annularly attached to and radially protrude from the outer surface of the metal rod (91). A base (94) is attached to the other end of the metal rod (91) and leads (96) protrude outward from the base (94) electrically to connect the LED (92) to a power source. A cover (95) overlies the LED 92. The cover (95) alters the illuminating pattern of the LED lamp and protects other structures of the LEDs lamp.

However, the metal rod (91) is not capable of satisfying heat transportation. Heat generated by the LED (92) during operation may not be effectively transferred, which forbids using high-power LED or using multiple LEDs within one LED lamp.

Accordingly, an LED lamp is needed that will mitigate or obviate the aforementioned problems.

### SUMMARY OF THE INVENTION

An embodiment of an LED lamp has a metal housing, a heat pipe and an LED.

In one embodiment, an open metal housing is bowl-shaped and comprises an outer surface, an inner surface, a bottom and an opening, wherein the opening has an inner edge. The heat pipe engages interior surfaces of the metal housing and comprises a bottom portion positioned toward the bottom of the metal housing. The LED is attached to the bottom portion of the heat pipe. In an embodiment, the heat pipe engages the metal housing at the inner surface, the bottom and at the opening.

The heat pipe rapidly transports heat generated by the LED to the metal housing. The metal housing then transfers the heat to the environment. The heat pipe makes effective heat transportation possible and allows the use of high-powered or multiple LED's within one lamp.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an LED lamp in accordance with the present invention;

FIG. 2 is an exploded perspective view of the LED lamp of FIG. 1;

FIG. 3 is a partial lateral cross-sectional view of the LED lamp of FIG. 1;

FIGS. 3A to 3G are cross sectional side views of embodiments of LED lamps in accordance with the present invention;

FIG. 3H is a perspective view of another embodiment of an LED lamp in accordance with the present invention;

FIG. 4 is an exploded perspective view of an LED lamp in accordance with the present invention having a spiraling heat pipe;

FIG. 5 is a side view, partially in cross-section of the LED lamp of FIG. 4;

FIG. 6 is a side view, partially in crosssection, of a conventional LED lamp in accordance with the prior art.

### DETAILED DESCRIPTION OF THE PREFERRED EMBODIMENTS

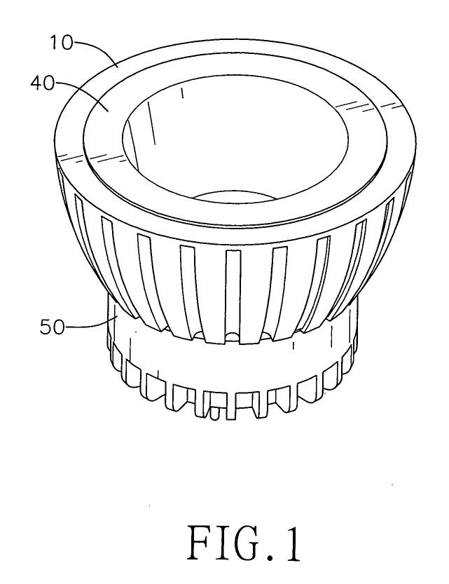

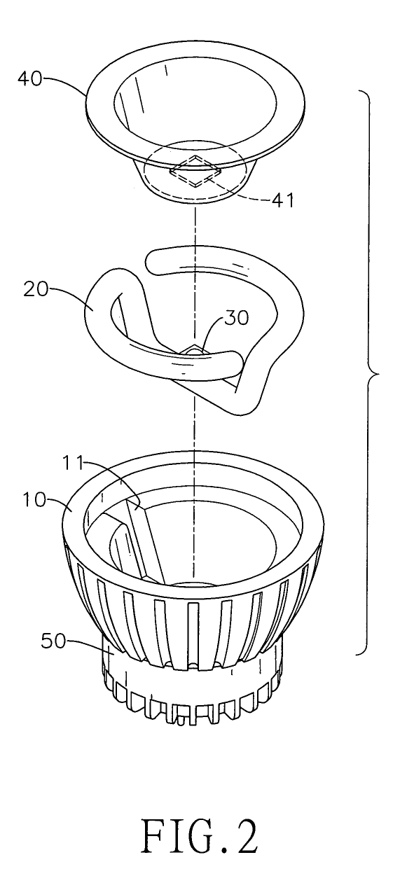

With reference to FIGS. 1 and 2, there is depicted an LED lamp embodiment having a metal housing (10), a heat pipe (20) and an LED (30). The metal housing (10) is bowl-shaped and comprises an outer surface, an inner surface, a bottom and an opening, wherein the opening has an inner edge. A base (50) may be attached to the outer surface corresponding to the bottom of the metal housing (10). The base (50) allows attachment of accessories and convenient usage.

The heat pipe (20) is mounted within the open metal housing (10) and is attached to the inner surface of the housing. The heat pipe (20) has a bottom portion positioned toward the bottom of the metal housing (10). In an embodiment, the bottom portion of the heat pipe engages an interior surface of the bottom of the housing. The inner surface of the metal housing (10) may be formed with one or more grooves for positioning the heat pipe (20). The heat pipe (20) may be welded or otherwise adhered to the inner surface of the metal housing (10) by using, for example, a thermal sticking agent such as thermal grease. With any of the aforementioned or other attaching means, the heat pipe (20) is attached to and thermally contacts the inner surface of the metal housing (10).

The LED (30) is attached to the bottom portion of the heat pipe (20). The LED (30) emits lights that radiates outward through the opening of the metal housing (10). In order to receive power for operation, the LED (30) is electrically connected to a power source providing an alternating current or a direct current.

The LED lamp may further comprise a controller electrically connected to the LED (30) and the power source. The controller is configurable for controlling the LED (30) such that the LED (30), for example, may switch between on-off status or to alternative illumination patterns. An artisan in the field of the present invention would appreciate the structure and installation of a suitable controller which need not be described herein.

Heat generated by the LED (30) during operation will be rapidly transported by the heat pipe (20) to the metal housing (10) and then sequentially transferred to the environment from the outer surface of the metal housing (10). The heat pipe (20) makes effective heat transportation possible and allows the use of high-powered or multiple LED's within one lamp.

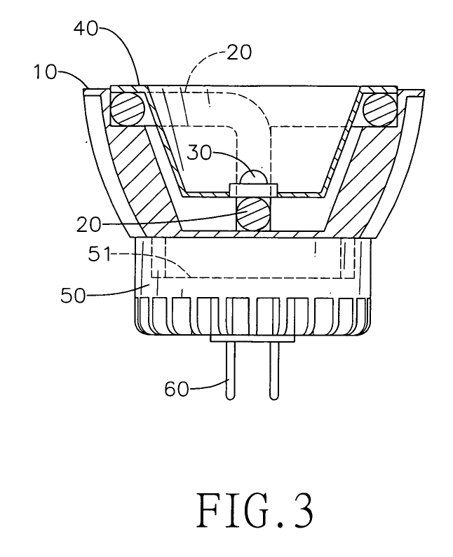

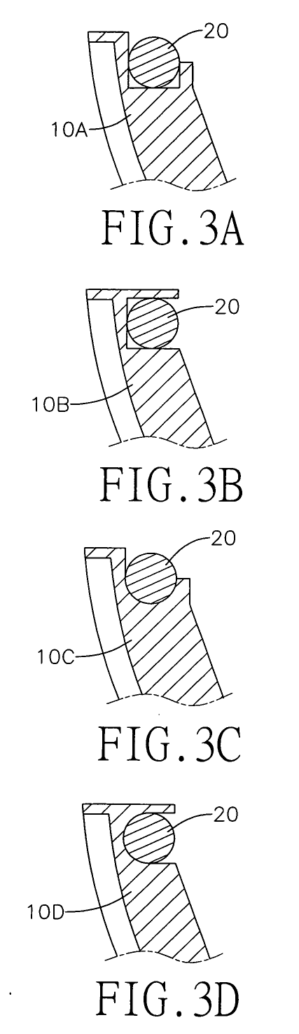

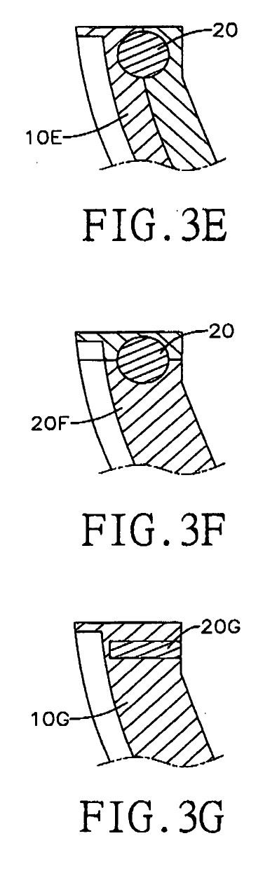

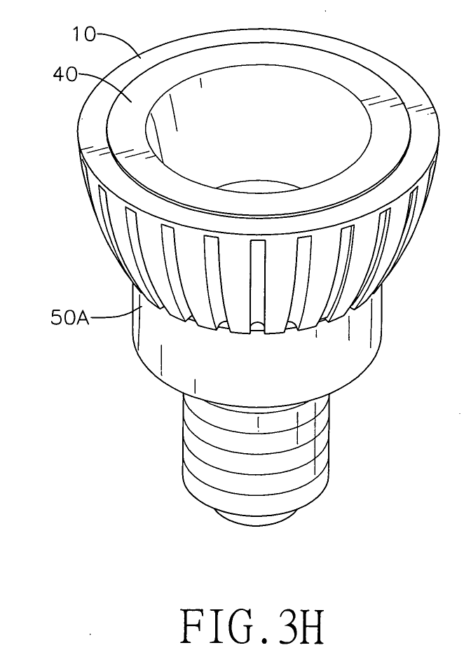

With reference to FIG. 3, an embodiment of the heat pipe (20) further has an upper portion being attached to and thermally contacting the inner edge of the metal housing. The inner edge may be formed by an inner positioning groove or recession formed near the opening of the metal housing (10) and adapted to receive the upper portion of the heat pipe, as described in more detail below. In an embodiment of the LED lamp, the heat pipe (20) has two lateral parts extending axially relative to the metal housing between the upper portion and the bottom portion of the heat pipe. The metal housing (10) has one or more grooves (11) (FIG. 2) formed axially on the inner surface of the metal housing (10). The bottom portion of the heat pipe is attached to the bottom of the metal housing (10). Each of the grooves (11) extends from the bottom of the housing to the opening of the metal housing (10). The lateral parts of the heat pipe (20) are respectively inserted in the grooves (11) and thermally connect the bottom, the inner surface and the inner edge of the opening of the metal housing (10). The shape and structure of the heat pipe (20) and inner edge of the opening of the metal housing (10) may be modified by persons skilled in the relevant art for attachment and thermal contact without departing from the scope of the invention. By way of example only, and with reference to FIG. 3, the inner edge of the opening of the metal housing (10) may form a recession. With reference to FIGS. 3A and 3B, the recession may be defined by a groove with a flat bottom formed axially or radially into the inner surface of the metal housing (10A, 10B). With reference to FIGS. 3C and 3D, a groove formed axially or radially into the metal housing (10C, 10D) may have a round bottom. With reference to FIGS. 3E and 3F, the heat pipe (20) may be embedded in the metal housing (10E, 10F). With reference to FIG. 3G, a radial slit may be formed into the metal housing (10G) and a flat heat pipe (20G) may be inserted in the slit. The recession may be peripheral as depicted in FIG. 2, or otherwise as determined by the skilled artisan.

With further reference to FIG. 3, a lead pair (60) may be used as a means to electrically connect the LED (30) to a suitable power source. The lead pair (60) protrudes out from the base (50) which is attached to the outer surface of the metal surface (10). The base (50) may further have a receiving space (51). The receiving space (51) is capable of receiving a controller being for example a suitable electronic circuit. A skilled artisan would appreciate that a suitable electronic circuit may be used to control the on-off state of the LED (30) and even the illumination pattern or style of the LED (30).

With reference to FIG. 3H, a substantially tubular base (50A) may also serve as a means to connect the LED (30) to a power source. In an embodiment, the tube extends from the outer surface of the bottom of the metal housing (10). The tubular base has a sealed end, an inner surface, an outer surface and a thread defined on the outer surface. The LED (30) is suitably electrically connected to a power source through the base (50A). The base (50A) is engaged mechanically and electrically with a threaded socket that is electrically connected to the power source. In an embodiment, the base (50, 50A) may be designed to engage with a MR-16 or E27 socket. A skilled artisan may modify or choose suitable base or electrical contact structure for electrically connecting the LED (30) to a power source without departing from the scope of the invention. With further reference to FIGS. 1 and 2, in an embodiment the LED lamp may further comprise a cover (40). The cover (40) covers the inner edge of the opening of the metal housing (10). The cover may be annular or it may be cup-like and may define a hole (41). The hole (41) allows the light emitted from the LED (30) to pass through it. The cover (40) helps to provide a different visual appearance of the LED lamp and protect the heat pipe (20) located in the inner edge of the opening of the metal housing (10). In an reflecting surface or may have a reflecting material applied to a surface upon which light from the LED is incident. Accordingly, the light emitted from the LED (30) can alternatively illuminate and provide different lighting or decoration effects.

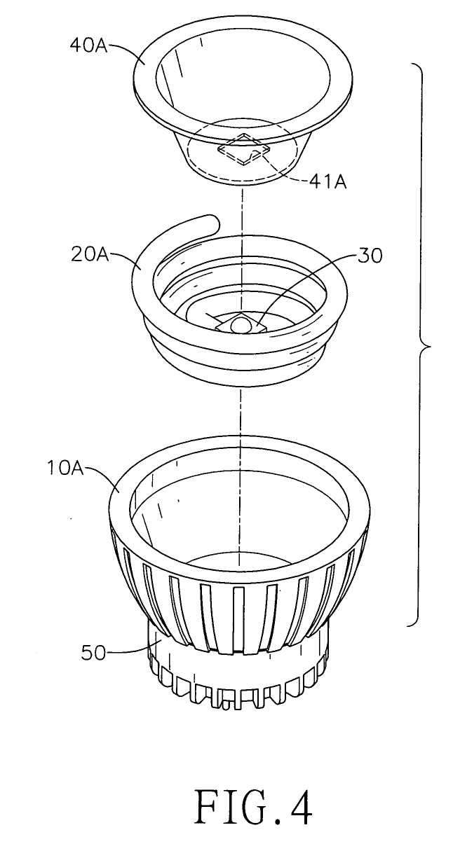

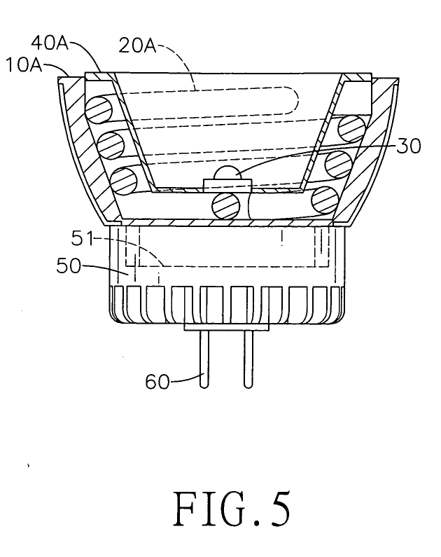

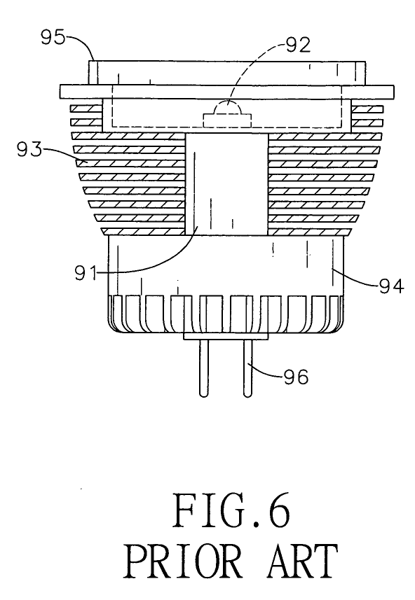

With reference to FIGS. 4 and 5, the heat pipe (20A) of another embodiment spirals on and thermally contacts the inner surface of the metal housing (10A). The heat pipe (20A) may engage the inner surface of the metal housing (10A) or be attached to the metal housing in various ways including adhered or welded to the inner surface of the metal housing (10A) without departing from the scope of the invention. Other feasible techniques would also be suitable for the attachment of the heat pipe (20A) to the inner surface of the metal housing (10A). A cover (40A) may also be attached to the inner edge of the opening of the metal housing (10A) for alternative lighting or decorating effects. In order to conveniently engage to the power source, the embodiment of the LED lamp may further comprise the aforementioned base (50, 50A) or lead pair (60).

Even though numerous characteristics and advantages of the various described embodiments have been set forth in the foregoing description, together with details of the structure and features, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A LED lamp comprising
a metal housing being bowl-shaped and comprising an inner surface, a bottom and an opening having an inner edge;
a heat pipe being attached to the inner surface, the bottom and the opening of the metal housing and comprising
a bottom portion being positioned to the bottom of the metal housing; and
an LED being attached to the bottom portion of the heat pipe.

2. The LED lamp as claimed in claim 1, wherein the heat pipe further has an opening portion being attached to and thermally contacting the inner edge of the opening of the metal housing.

3. The LED lamp as claimed in claim 1, wherein the heat pipe spirals on and thermally contacts the inner surface of the metal housing.

4. The LED lamp as claimed in claim 1 further comprising a cover covering the inner edge of the opening of the metal housing and comprising a hole allowing a light emitted from the LED to pass through.

5. The LED lamp as claimed in claim 2 further comprising a cover covering the inner edge of the opening of the metal housing and comprising a hole allowing a light emitted from the LED to pass through.

6. The LED lamp as claimed in claim 3 further comprising a cover covering the inner edge of the opening of the metal housing and comprising a hole allowing a light emitted from the LED to pass through.

7. An LED lamp comprising:
a metal housing open at one end;
a heat pipe within said metal housing engaging an interior side wall surface thereof adjacent the open end, said heat pipe having a lower portion positioned toward the closed end of the metal housing; and
an LED attached to said lower portion of said heat pipe.

8. The LED lamp of claim 7 in which said lower portion of the heat pipe thermally engages an interior surface of the closed end of the metal housing.

9. The LED of claim 7 in which said heat pipe engages the interior side wall surface of said metal housing between the open end and closed end thereof.

10. The LED lamp of claim 9 in which said metal housing has at least one axial groove formed in the interior side wall surface thereof and said heat pipe has at least one axially extending portion thermally engaging the metal housing within said at least one axial groove.

11. The LED lamp of claim 7 in which the interior side wall surface of said metal housing has a peripheral recession at the open end of the metal housing and said heat pipe has an upper portion thermally engaging the metal housing within said peripheral recession.
